(19) United States
(12) Patent Application Publication
(10) Pub. No.: US 2021/0027637 A1
(43) Pub. Date: Jan. 28, 2021

(54) METHOD AND ELECTRONIC DEVICE FOR MANAGING THE DISPLAY OF A FIELD MAP FOR AN AIRCRAFT, RELATED COMPUTER PROGRAM AND DISPLAY SYSTEM

(71) Applicant: Thales, Courbevoie (FR)

(72) Inventors: Patrick CAZAUX, Merignac (FR); Dominique Leurgorry, Merignac (FR)

(21) Appl. No.: 16/936,186

(22) Filed: Jul. 22, 2020

(30) Foreign Application Priority Data
Jul. 22, 2019 (FR) FR 19 08282

(51) Int. Cl. G08G 5/00; G01C 23/00; G08G 5/04; B64D 43/00

(52) U.S. Cl. CPC G08G 5/0047; B64D 43/00; G08G 5/045; G01C 23/005

(57) ABSTRACT

This method for managing the display of a field map for an aircraft is implemented by an electronic device and comprising the following steps:
acquiring a reference altitude of the aircraft, using an automatic mode in which the reference altitude depends on a current altitude of the aircraft or a manual mode in which the reference altitude depends on an altitude value entered by a user via an entry interface;
determining cartographical element(s) based on the reference altitude; and
generating the field map.

During the acquisition step, the manual mode is activated if an interaction by the user with the entry interface is detected, and the automatic mode is activated if no interaction with said interface is detected, and this step includes switching to the automatic mode if a switching condition is met.

### CROSS-REFERENCE WITH RELATED APPLICATIONS

This application is a non-provisional American application claiming the benefit of French application no. 19 08282, filed on Jul. 22, 2019, which is incorporated here by reference in its entirety.

### FIELD

The present invention relates to a method for managing the display of a field map for an aircraft, the method being implemented by an electronic display management device.

The invention also relates to a non-transitory computer-readable medium comprising a computer program including software instructions which, when executed by a computer, implement such a display management method.

The invention also relates to an electronic management device for managing the display of a field map for an aircraft.

The invention also relates to an electronic system for displaying a field map for an aircraft, comprising a display screen and such an electronic management device configured to manage the display of the field map on the display screen.

The invention then relates to the field of man-machine interfaces (MMI) for piloting an aircraft, preferably intended to be installed in an aircraft cockpit.

The invention in particular relates to the display of field maps, showing a terrain intended to be overflown by the aircraft, for example a two-dimensional (2D) display in top view.

The display of such a field map is intended to be used on the ground to prepare an aeronautical mission, or on board the aircraft on an on-board display system for preparation, monitoring and/or new planning of the aeronautical mission.

The display of such a field map aims to provide a clear and coherent overview of the situation, in particular to facilitate the viewing of cartographic elements, such as relief zones, obstacles, air sectors, airways, or meteorological information.

### BACKGROUND

On so-called aircraft mission screens, a function is known making it possible to color the digital map of the terrain based on the height of each relief zone shown on the field map and a reference altitude of the aircraft.

To that end, an electronic device is known for managing the display of an aircraft field map, comprising a module for acquiring said reference altitude, a module for determining first relief zone(s) having a height above the reference altitude and second relief zone(s) having a height below or equal to the reference altitude, as well as a module for generating the field map, where said field map includes a first representation for each first relief zone and a second representation for each second relief zone, each second representation being separate from each first representation.

As an example, each first relief zone is colored in red, and each second relief zone has an unchanged color relative to an initial field map, typically coming from a navigation database. According to this example, each first representation is then colored red, and each second representation is then an absence of modification of the initial color of the field map. This initial coloring typically has beige tones for the low altitude zones, green tones for the medium altitude zones and yellow tones for the highest altitude zones. There are then typically different representation variants with different color levels corresponding to different altitude brackets, such as altitude brackets with a height of 100 feet.

Such a field map with coloring of each relief zone based on the height of said relief zone is for example called HAT (Height Above Terrain) mapping or submerged land mapping, or Terrain Conflicts or Ground Proximity.

In order to acquire the reference altitude of the aircraft, two methods, or two modes, are known in order to acquire this reference altitude, namely on the one hand, an automatic mode in which the reference altitude depends on the current altitude of the aircraft, and on the other hand, a manual mode in which the reference altitude depends on an altitude value entered by the user, such as the pilot or the copilot of the aircraft, via a reference altitude entry interface.

In the automatic acquisition mode, the reference altitude then depends on the current altitude of the aircraft, and the coloring of the terrain is done automatically taking said current altitude of the aircraft into account. This embodiment is perfectly suited to in-flight use, where the aim is to monitor the safety of the aircraft relative to the overflown terrain.

In the manual acquisition mode, the reference altitude depends on the altitude value entered by the user, and the coloring of the terrain is then done relative to this entered altitude. This embodiment is perfectly suited to mission preparation on the ground.

However, this manual acquisition mode is very risky for in-flight use, since the coloring then does not represent the situation relative to the current altitude of the aircraft, but relative to an altitude entered by the user that may be greater than the current altitude of the aircraft. The user may then believe he is safe relative to the terrain whereas the aircraft is in reality very close to the ground.

### SUMMARY

The aim of the invention is then to propose a method and an electronic device for managing the display of a field map, making it possible to improve the display of cartographical element(s), such as relief zone(s), obstacle(s), air sector(s), airway(s), or meteorological information, and then to improve the safety of the flight.

To that end, the invention relates to a method for managing the display of a field map for an aircraft, the method being implemented by an electronic management device and comprising the following steps:
acquiring a reference altitude of the aircraft, using a mode chosen from an automatic mode in which the reference altitude depends on a current altitude of the aircraft and a manual mode in which the reference altitude depends on an altitude value entered by a user via a reference altitude entry interface;
determining cartographical element(s) based on the reference altitude;
generating the field map, said map including a representation for each cartographical element; and

during the acquisition, the manual mode is activated if an interaction by the user with the reference altitude entry interface is detected, and the automatic mode is activated if no interaction with said entry interface is detected,

the acquisition further includes switching from the manual mode to the automatic mode if a switching condition is met, and

when the aircraft is in flight, the switching condition is the end of the interaction by the user with the reference altitude entry interface.

Thus, the display management method according to the invention makes it possible to manage, more easily and under better safety conditions, both acquisition modes of the reference altitude, namely the automatic mode and the manual mode, the manual mode being activated only if an interaction by the user with the reference altitude entry interface is detected, and the automatic mode being activated otherwise, that is to say if no interaction with said entry interface is detected.

Furthermore, during the acquisition of said reference altitude of the aircraft, the switching from the manual mode to the automatic mode is done once a switching condition is met.

Preferably, when the aircraft is in flight, the switching condition is the end of the interaction by the user with the reference altitude entry interface, such that the switching from the manual mode to the automatic mode is done once the user no longer interacts with the reference altitude entry interface. In other words, when the aircraft is in flight, the default mode for acquiring the reference altitude is the automatic mode, and the manual mode is activated only in case of interaction by the user and maintenance thereof, so as to prevent the reference altitude taken into account to next determine the cartographical element(s) from remaining the altitude value entered by the user, whereas he is no longer aware of it.

Also preferably, when the aircraft is on the ground, the switching condition is the expiration of a time delay triggered at the end of the interaction by the user with the reference altitude entry interface, or an interaction by the user with a switching interface in automatic mode. In other words, when the aircraft is on the ground, the switching from manual mode to automatic mode is done automatically on command by the user via the interaction with said switching interface, or otherwise automatically upon expiration of the time delay that was triggered after the last interaction with the reference altitude entry interface, said time delay for example being substantially equal to 60 seconds.

According to other advantageous aspects of the invention, the display management method comprises one or more of the following features, considered alone or according to all technically possible combinations:
when the aircraft is on the ground, the switching condition is chosen from the group consisting of: the expiration of a time delay triggered at the end of the interaction by the user with the reference altitude entry interface; and an interaction by the user with a switching interface in automatic mode;
the reference altitude entry interface is associated with an altitude scale representing a range of reference altitude values, with an aircraft symbol indicating a current value of the reference altitude, the aircraft symbol being movable along the altitude scale, the altitude scale and the aircraft symbol being intended to be displayed superimposed on the field map,

the reference altitude entry interface preferably including a member for selecting the aircraft symbol and a member for moving a value tag appearing after a selection of the aircraft symbol,

the reference altitude entry interface is preferably touch-sensitive;
the method further comprises detecting a situation of invalidity of the current altitude of the aircraft, such as a lack of measurement of the current altitude or a disrupted measurement of the current altitude, and the generating then further includes generating an invalidity symbol of the current altitude;
during the acquisition in the automatic mode, the reference altitude is equal to the current altitude of the aircraft minus a predetermined margin,

the predefined margin preferably being substantially equal to 300 feet,

the predefined margin also preferably being configurable in the plant;
each cartographical element is chosen from the group consisting of: a relief zone, an obstacle, an airspace, an airway and meteorological information;
the determining includes determining first cartographical element(s), and respectively second cartographical element(s), based on the reference altitude, and the generating includes generating a first representation for each first cartographical element and a second representation for each second cartographical element, each second representation being separate from each first representation,

preferably, when the first and second cartographical element(s) are each a relief zone, or respectively an obstacle, each first cartographical element has a reference height greater than the reference altitude, and each second cartographical element has a reference height less than or equal to the reference altitude,

also preferably, when the first and second cartographical element(s) are each an airspace, or respectively an airway, each first cartographical element has a range of altitudes including the reference altitude, and each second cartographical element has a range of altitudes not including the reference altitude;
the method further comprises displaying the field map on a display screen,

the displaying step preferably further including the display of a position symbol representative of the position of the aircraft;
when the current value of the reference altitude is not included in the range of reference altitude values corresponding to the altitude scale, the generating step further includes generating an out-of-range symbol representative of the current value of the reference altitude not included in said range of reference altitude values; and
if the current value of the reference altitude is above said range of reference altitude values, the out-of-range symbol has a first shape, and

if the current value of the reference altitude is below said range of reference altitude values, the out-of-range symbol has a second shape, separate from the first shape.

The invention also relates to a non-transitory computer-readable medium comprising computer program including software instructions which, when executed by a computer, implement a flight management method, as defined above.

The invention also relates to an electronic management device for managing the display of a field map for an aircraft, the device comprising:
an acquisition module configured to acquire a reference altitude of the aircraft, using a mode chosen from an automatic mode in which the reference altitude depends on a current altitude of the aircraft and a manual mode in which the reference altitude depends on an altitude value entered by a user via a reference altitude entry interface;
a determining module configured to determine one or several cartographical element(s) based on the reference altitude;
a generating module configured to generate the field map, said map including a representation for each cartographical element,

the acquisition module being configured to activate the manual mode if an interaction by the user with the reference altitude entry interface is detected, and to activate the automatic mode if no interaction with said entry interface is detected,

the acquisition module further being configured to switch from the manual mode to the automatic mode if a switching condition is met, and

when the aircraft is in flight, the switching condition is the end of the interaction by the user with the reference altitude entry interface.

The invention also relates to an electronic system for displaying a field map for an aircraft, the system comprising a display screen and an electronic management device configured to manage the display of the field map on the display screen, the electronic management device being as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of an electronic system according to the invention for displaying a field map for an aircraft, the display system comprising a display screen and an electronic device for managing the display of the field map on the display screen, the management device including a module for acquiring a reference altitude of the aircraft in an automatic mode in which the reference altitude depends on a current altitude of the aircraft or in a manual mode in which the reference altitude depends on a value entered by a user via a dedicated entry interface, a module for determining cartographical element(s) based on the reference altitude, and a module for generating the field map;

FIG. 2 is a view illustrating the field map generated by the generating module and intended to be displayed on the display screen, when the aircraft is in flight and according to the automatic acquisition mode;

FIG. 3 is a view similar to that of FIG. 2, when the aircraft is in flight and in the manual acquisition mode;

FIG. 4 is a view similar to that of FIG. 2, when the aircraft is on the ground and in the automatic acquisition mode;

FIG. 5 is a view similar to that of FIG. 2, when the aircraft is on the ground and in the manual acquisition mode; and

FIG. 6 is a flowchart of a method, according to the invention, for managing the display of the field map for the aircraft.

### DETAILED DESCRIPTION OF THE INVENTION

In the remainder of the description, the expression “substantially equal to” defines a relationship of equality to within +/−10%, preferably to within +/−5%.

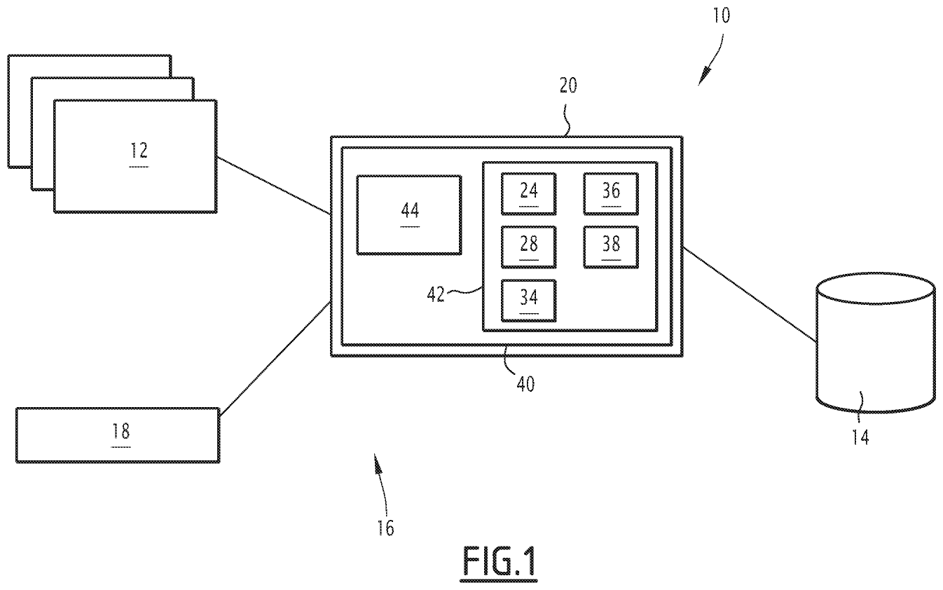

In FIG. 1, an aircraft 10 comprises several avionics systems 12, a database 14 and an electronic display system 16, the display system 16 including a display screen 18 and an electronic device 20 for managing the display of a field map 22 on the display screen 18, also called display management device.

The aircraft 10 is for example an airplane. In a variant, the aircraft 10 is a helicopter, or a drone able to be piloted remotely by a pilot.

Avionics systems 12 are known in themselves and are able to send the electronic display system 10, and in particular the electronic management system 20, different avionic data, for example so-called “aircraft” data, such as the position, the orientation, the heading or the altitude of the aircraft 10, and/or so-called “navigation” data, such as a flight plan.

The database 14 is typically a terrain database, and is known in itself. The terrain database in particular includes data relative to the terrain that may be overflown by the aircraft 10.

The electronic display system 16 is configured to display the field map 22, such as an HAT (Height Above Terrain) map, and comprises the display screen 18 and the electronic management device of the display 20 that is connected to the display screen 18, the avionics systems 12 and the database 14.

The display screen 18 is known in itself. The display screen 18 is preferably a touchscreen, so as to allow the entry of interaction(s) by a user, not shown, such as the pilot or the copilot of the aircraft 10.

The display management device 20 is configured to manage the display of the field map 22 on the display screen 18, and comprises a module 24 for acquiring a reference altitude of the aircraft 10, using a mode chosen from an automatic mode, also called first mode M1, in which the reference altitude depends on a current altitude of the aircraft 10, and a manual mode, also called second mode M2, in which the reference altitude depends on an altitude value entered by the user via a reference altitude entry interface 26.

The display management device 20 also comprises a module 28 for determining cartographical element(s) 30, 32, such as one or several first cartographical element(s) (30), and respectively one or several second cartographical element(s) (32), based on the reference altitude, as well as a module 34 for generating the field map 22.

As an optional addition, the display management device 20 further comprises a module 36 for displaying the field map 22 on the display screen 18.

Also as an optional addition, the display management device 20 further comprises a module 38 for detecting a situation of invalidity of the current altitude of the aircraft 10, such as the absence of measurement of the current altitude or a disrupted measurement of said current altitude.

In the example of FIG. 1, the display management device 20 comprises an information processing unit 40, for example made up of a memory 42 and a processor 44 associated with the memory 42.

In the example of FIG. 1, the acquisition module 24, the determining module 28 and the generating module 34, as well as, optionally and additionally, the display module 36 and the detection module 38, are each made in the form of software, or a software component, executable by the processor 44. The memory 42 of the display management device 20 is then able to store software for acquiring the reference altitude in the automatic mode M1 or in the manual mode M2, software for determining cartographical elements 30, 32, and software for generating the field map 22. As an optional addition, the memory 42 of the display management device 20 is able to store software for displaying the field map 22 on the display screen 18 and software for detecting the situation of invalidity of the current altitude of the aircraft 10. The processor 44 is then capable of executing each of the software applications from among the acquisition software, the determining software and the generating software, as well as, by way of optional addition, the display software and the detection software.

In a variant that is not shown, the acquisition module 24, the determining module 28 and the generating module 34, as well as, optionally and additionally, the display module 36 and the detection module 38, are each made in the form of a programmable logic component, such as an FPGA (Field Programmable Gate Array), or of an integrated circuit, such as an ASIC (Application-Specific Integrated Circuit).

When the display management device 20 is made in the form of one or several software programs, i.e., in the form of a computer program, it is further able to be stored on a medium, not shown, readable by computer. The computer-readable medium is for example a medium suitable for storing the electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

The field map 22 is a map showing one or several cartographical elements 30, 32, intended to be overflown by the aircraft 10. The field map 22 in particular includes different representations of cartographical elements 30, 32 based on reference heights, or altitude ranges, of the cartographical elements 30, 32 and the reference altitude of the aircraft 10, so as to allow the user to become aware of the situation of the aircraft 10 relative to its environment and to then anticipate future changes in trajectory of the aircraft 10 so as to preserve altitude margins with respect to the terrain meant to be overflown by the aircraft 10.

The field map 22 is then for example an HAT (Height Above Terrain) map, or a so-called submerged land map, or a so-called terrain conflicts map, or a so-called ground proximity map.

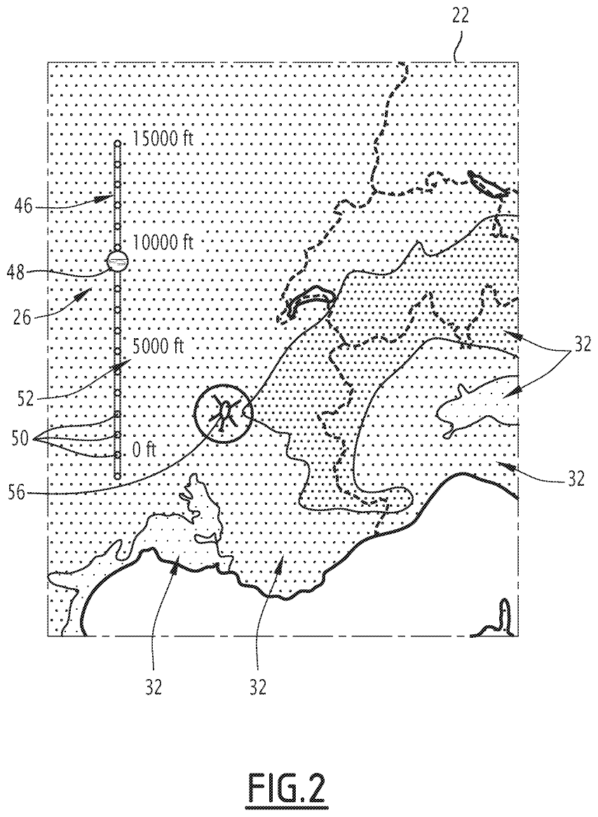

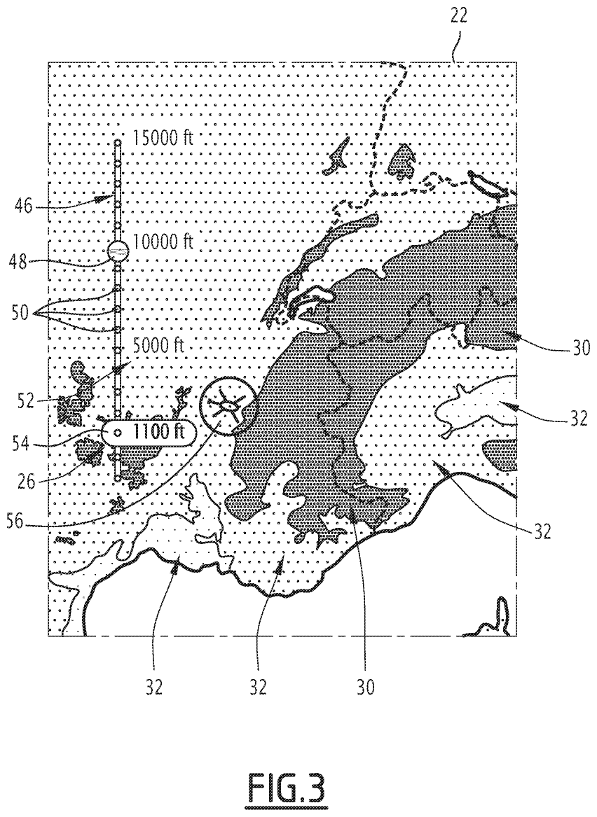

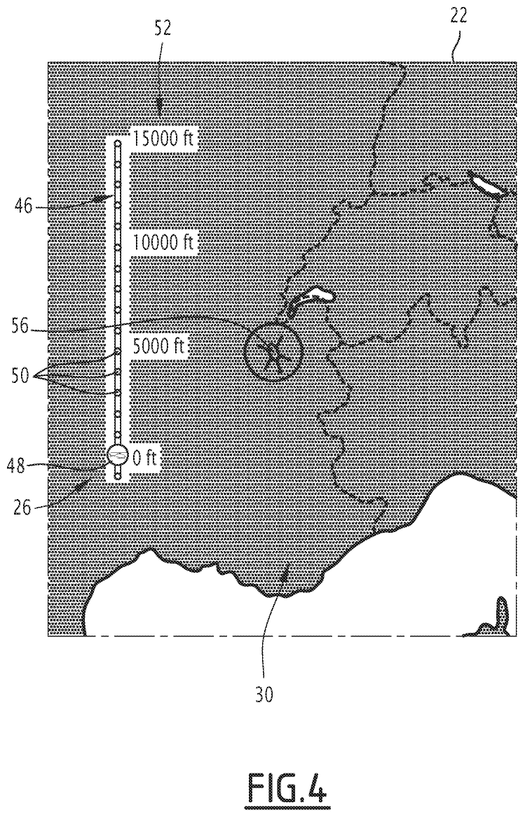

The field map 22 then includes a first representation for each first cartographical element 30 and a second representation for each second cartographical element 32, each second representation being separate from each first representation. The first and second representations are for example based on respective colorings of the shown cartographical elements 30, 32, as will be described in more detail hereinafter. In a variant, the first and second representations are based on respective fills of the first 30 and second 32 shown cartographical elements, for example on fills with dots, that is to say in the form of clouds of points, where the density of the points and/or the size of the points varies from one representation to the other, as shown in FIGS. 2 to 5. According to this variant, the first representation associated with each first cartographical element 30 for example has a density of points higher than that of the second respective representation for each second cartographical element 32.

In the example of FIGS. 2 to 5, the first representation for each first cartographical element 30 is for example a red coloring of each first cartographical element 30, this red coloring corresponding to a dense representation of thick points in FIGS. 2 to 5, and the second representation for each second cartographical element 32 for example corresponds to an unchanged coloring of each second cartographical element 32, this unchanged coloring then typically going from a beige color for the second cartographical elements 32 of low altitude to a yellow color for the second cartographical elements 32 of high altitude by way of a green color for the second cartographical elements 32 of medium altitude, corresponding to more or less dense representations of thin or thick points in FIGS. 2 to 5.

A second respective representation is preferably associated with each second cartographical element 32, with different representation levels, such as different color levels or density and/or thickness of cloud of point levels, corresponding to different altitude brackets of the second cartographical elements 32, such as altitude brackets of 100 feet (ft) in height each, or altitude brackets of 200 ft in height each.

By convention in the example of FIGS. 2 to 5, for a same type of points, a less dense representation of points for example corresponds to a second cartographical element 32 of lower altitude than that of a second cartographical element 32 associated with a denser representation of points. Similarly in this example of FIGS. 2 to 5, for a same density of points, a thinner representation of points for example corresponds to a second cartographical element 32 of lower altitude than that of a second cartographical element 32 associated with a thicker representation of points.

The acquisition module 24 is configured to acquire the reference altitude of the aircraft 10 according to one mode among the automatic mode M1 in which the reference altitude depends on the current altitude of the aircraft 10 and the manual mode M2 in which the reference altitude depends on a value entered by the user via the entry interface 26. In other words, the acquisition module 24 is configured to acquire the reference altitude of the aircraft 10 according to the first mode M1 where the reference altitude depends on the current altitude of the aircraft 10 or according to the second mode M2 where the reference altitude depends on a value entered by the user via the entry interface 26.

The acquisition module 24 is also configured to activate the manual mode (or second mode) M2 if an interaction by the user with the reference altitude entry interface 26 is detected, and to activate the automatic mode (or first mode) M1 if no interaction with said entry interface 26 is detected.

The acquisition module 24 is further configured to switch from the manual mode (or second mode) M2 to the automatic mode (or first mode) M1 if a switching condition is verified, that is to say once a respective switching condition is met. As an optional addition, when the aircraft 10 is in flight, that is to say in the “aircraft in flight” condition, the switching condition is the end of the interaction by the user with the reference altitude entry interface 26. Preferably, when the aircraft 10 is in flight, the end of the interaction by the user with said entry interface 26 is the only switching condition. When the aircraft 10 is in flight, the passage to automatic mode (or first mode) M1 is done while the user no longer interacts with the reference altitude entry interface 26.

As another optional addition, when the aircraft 10 is on the ground, that is to say in “aircraft on the ground” condition, the switching condition is chosen from the group consisting of: the expiration of a time delay triggered at the end of the interaction by the user with the reference altitude entry interface 26; and an interaction by the user with a switching interface, not shown, in automatic mode M1. As another addition, when the aircraft 10 is on the ground, the expiration of said time delay and the interaction of the user with the switching interface in automatic mode M1 preferably form the only two switching conditions. When the aircraft 10 is on the ground, the passage to automatic mode M1 is then done manually upon interaction by the user with the switching interface in automatic mode M1, or automatically upon expiration of the time delay that was triggered after the last interaction by the user with the reference altitude entry interface 26. Said time delay for example has a duration substantially equal to 60 seconds. The duration of said time delay is preferably configurable, in particular in the plant.

In the automatic mode M1 (or first mode), the acquisition module 24 is for example configured to acquire the reference altitude as being equal to the current altitude of the aircraft 10 minus a predefined margin. The predefined margin is preferably substantially equal to 300 feet, or 300 ft. The predefined margin is preferably configurable, in particular in the plant.

In the manual mode M2 (or second mode), the acquisition module 24 is for example configured to acquire the reference altitude as being equal to the altitude value entered by the user with a predefined precision. In other words, the acquisition module 24 is configured to acquire the reference value as being equal to the rounded-off value, with the predefined precision, of the altitude value entered by the user via the entry interface 26. The predefined precision is preferably configurable, in particular in the plant.

The predefined precision is substantially equal to 100 feet. In other words, according to this example, the acquisition module 24 is configured to acquire the reference value as being equal to the value rounded off to the closest hundred feet of the altitude value entered by the user via the entry interface 26.

The reference altitude entry interface 26 is preferably a touch-sensitive interface. In a variant or in addition, the reference altitude entry interface 26 is an interface implementing entry means, not shown, such as a keyboard and/or a mouse.

In the example of FIGS. 2 to 5, the reference altitude entry interface 26 is associated with an altitude scale 46 representing a range of reference altitude values, with an aircraft symbol 48 indicating a current value of the reference altitude, the aircraft symbol 48 being movable along the altitude scale 46. The altitude scale 46 and the aircraft symbol 48 are intended to be displayed superimposed on the field map 22, preferably once the field map 22 is displayed.

The range of reference altitude values is inclusively between a lower reference altitude bound, that is to say a minimum value, and an upper reference altitude bound, that is to say maximum value. The lower and upper reference altitude bounds are preferably configurable, in particular in the plant. The lower reference altitude bound is for example substantially equal to −1000 feet, and the upper reference altitude bound is for example substantially equal to +15,000 feet. The altitude scale 46 further includes graduations 50, so as to improve the readability of the scale 46, these graduations 50 for example being scaled every 1000 feet, further with a value legend 52 every 5000 feet, as shown in FIGS. 2 to 5.

According to this example, the reference altitude entry interface 26 preferably includes a member for selecting the aircraft symbol 48 and a member for moving a value tag 54 appearing after a selection of the aircraft symbol 48. The selection member and the movement member are preferably members associated with a touch-sensitive interface, the aircraft symbol 48 then being able to be selected by touch by the user, and the value tag 54 then also being able to be moved by touch by the user, typically by a sliding movement by a finger of the user after selection of the aircraft symbol 48.

In a variant, not shown, the reference altitude entry interface 26 is in the form of an entry field. The entry field then allows the entry of the altitude value by the user directly in the form of a series of alphanumeric characters.

The determining module 28 is configured to determine one or several cartographical element(s) 30, 32 based on the reference altitude.

The determining module 28 is preferably configured to determine, based on said reference altitude, one or several first cartographical element(s) 30, respectively one or several second cartographical element(s) 32, preferably when the first 30 and second 32 cartographical element(s) are each a relief zone, or respectively an obstacle, or respectively an airspace, or respectively an airway.

The determining module 28 is for example configured to determine one or several first cartographical element(s) 30 having a reference height greater than the reference altitude and one or several second cartographical element(s) 32 having a reference height less than or equal to the reference altitude, when the first 30 and second 32 cartographical element(s) are each a relief zone, or respectively an obstacle. In other words, when the first 30 and second 32 cartographical element(s) are each a relief zone, or respectively an obstacle, the determining module 28 is configured to discriminate, or sort, between the first cartographical element(s) 30 located above the reference altitude and the second cartographical element(s) 32 located below the reference altitude. The determining module 28 is typically configured to make this determination by comparing the reference height of each cartographical element 30, 32 with the reference altitude acquired by the acquisition module 24.

The reference height of each cartographical element 30, 32 is typically its maximum height, or its elevation, when the cartographical element 30, 32 is a relief zone, or an obstacle.

The determining module 28 is for example configured to determine one or several first cartographical element(s) 30 having a range of altitudes including the reference altitude and one or several second cartographical element(s) 32 having a range of altitudes not including the reference altitude, that is to say a range of altitudes outside the reference altitude, or separate from said reference altitude, when the first 30 and second 32 cartographical element(s) are each an airspace, or respectively an airway. In other words, when the first 30 and second 32 cartographical element(s) are each an airspace, or respectively an airway, the determining module 28 is configured to discriminate, or sort, between the first cartographical element(s) 30 whose range of altitudes includes the reference altitude and the second cartographical element(s) 32 whose range of altitudes does not include the reference altitude of the aircraft 10. The determining module 28 is typically configured to make this determination by detecting whether the reference altitude of the aircraft 10 acquired by the acquisition module 24 belongs to the range of altitudes associated with each cartographical element 30, 32.

The range of altitudes of each cartographical element 30, 32 is typically an interval of altitudes inclusively between a minimum altitude bound and a maximum altitude bound, when the cartographical element 30, 32 is an airway or an airspace, such as a controlled airspace or a prohibited airspace.

Each cartographical element 30, 32 is preferably chosen from the group consisting of: a relief zone, an obstacle, an airspace, an airway and meteorological information.

In the example of FIGS. 2 to 5, each cartographical element 30, 32 is a respective relief zone. From this example of FIGS. 2 to 5, one skilled in the art will conceive of other variants without difficulty where the cartographical elements 30, 32 are obstacles, or airspaces, or airways, or even meteorological information.

As an optional addition, the field map 22 comprises a mixture of at least two different types of cartographical elements 30, 32, where each type is chosen from the group consisting of: a relief zone, an obstacle, an airspace, an airway and meteorological information.

Each relief zone is for example characterized by a set of latitude and longitude points, wherein each point has a height, or elevation, inclusively within a predefined range of heights. The ranges of heights are for example predefined by altitude brackets, such as altitude brackets of 100 feet in height. According to this example, the height ranges are then the following successive ranges: [0 ft; 100 ft], [100 ft; 200 ft], [200 ft; 300 ft], [300 ft; 400 ft], [400 ft; 500 ft], etc. The reference height of said relief zone is then typically its maximum height, or its elevation, that is to say the altitude of the highest point among the set of points forming the relief zone.

Each obstacle is for example chosen from among the group consisting of: an individual obstacle, a group of obstacles, a wind turbine and a group of wind turbines. Each obstacle is preferably defined according to Annex 4 by the ICAO (International Civil Aviation Organization), titled “Aeronautical Charts”; or according to the FAA (Federal Aviation Administration) Aeronautical Chart User's Guide.

Each airspace is typically defined by a minimum altitude bound and a maximum altitude bound characterizing the range of altitudes associated with the airspace, as well as a geographical contour characterizing, by latitude and longitude, a set of points associated with the airspace. Each airspace is for example a controlled airspace or a prohibited airspace.

Each airway is also typically defined by a minimum altitude bound and a maximum altitude bound characterizing the range of altitudes associated with the airway, as well as a geographical contour characterizing, by latitude and longitude, a set of points associated with said airway.

Each meteorological information item is typically a temperature information item, a wind, cloud density, ice zone information item, or a turbulence information item, this meteorological information item preferably being intended to be displayed for the acquired reference altitude. Each meteorological information item is for example obtained from a sensor equipping the aircraft 10 or a meteorological message received by the aircraft 10 from an embedded sensor of the weather radar type or a meteorological information broadcast system. Each meteorological information item and/or each meteorological message are preferably defined according to Annex 3 by the ICAO (International Civil Aviation Organization), titled “Meteorological Service for International Air Navigation”.

The generating module 34 is configured to generate the field map 22, in particular based on first 30 and second 32 cartographical elements determined by the determining module 28, the map 22 including, if applicable and as previously described, a first representation for each cartographical element 30 and a second representation for each second cartographical element 32, each second representation being separate from each first representation.

When the cartographical element is a meteorological information item, the generating module 34 is preferably configured to generate a unique representation for said meteorological information item, this unique representation then being intended to be displayed opposite the reference altitude of the aircraft 10.

As an optional addition, the generating module 34 is configured further to generate the altitude scale 46 previously described with the aircraft symbol 48, the graduations 50, the value legends 52, and if applicable the value tag 54.

As an optional addition, the generating module 34 is configured further to generate a position symbol 56 representative of the geographical position of the aircraft 10, the aircraft symbol 48, previously described, in turn being representative of the current value of the reference altitude of the aircraft 10.

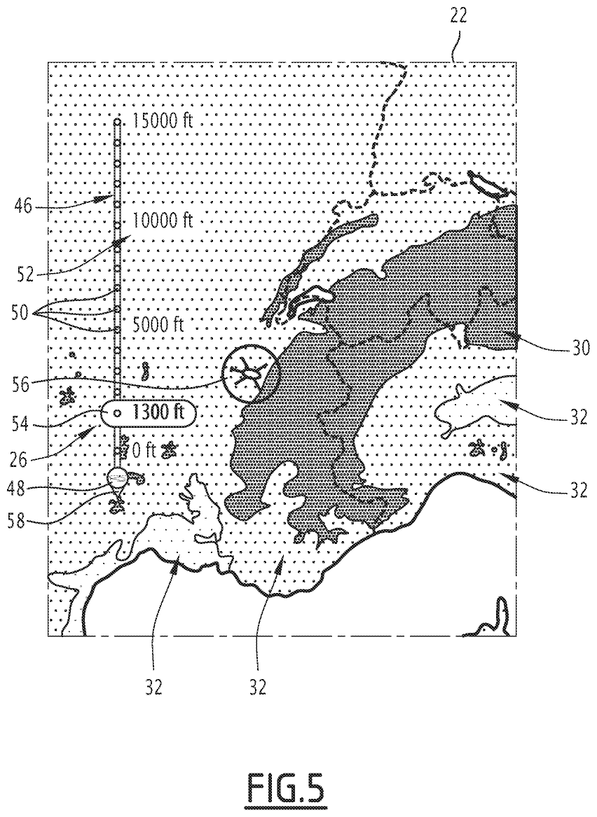

As another optional addition, the generating module 34 is further configured to generate, when the current value of the reference altitude of the aircraft 10 is not included in the range of reference altitude values corresponding to the altitude scale 46, an out-of-range symbol 58 representative of the current value of the reference altitude not included in said range of reference altitude values. According to this optional addition, the generating module 34 is further preferably configured to generate the out-of-range symbol 58 with a first shape of the current value if the reference altitude is above said range of reference altitude values, and a second shape, separate from the first shape, if the current value of the reference altitude is below said range of reference altitude values, as illustrated in FIG. 5.

In the example of FIGS. 2 to 5, the first shape is a triangular shape oriented upward, so as to indicate that the current value of the reference altitude is above the range of reference altitude values, and the second shape is a triangular shape oriented downward, so as to indicate in this case that the current value of the reference altitude is below said range of reference altitude values.

The display module 36 is then configured to display the field map 22 on the display screen 18, preferably in top view. The display module 36 is configured to display, as an optional addition, the altitude scale 46, the aircraft symbol 48, the graduations 50, the value legends 52, if applicable the value tag 54, the position symbol 56, and if applicable the out-of-range symbol 58.

As an optional addition, the detection module 38 is configured to detect a situation of invalidity of the current altitude of the aircraft 10, such as an absence of measurement of the current altitude or a disrupted measurement of the current altitude. According to this optional addition, the generating module 34 is then configured to further generate a symbol, not shown, for invalidity of the current altitude, and the display module 36 is also configured to display the invalidity symbol of the current altitude. According to this optional addition, the generating module 34 is preferably configured to generate said invalidity symbol of the current altitude in place of the aircraft symbol 48, and the display module 36 is similarly configured to display said current altitude invalidity symbol in place of the aircraft symbol 48. The invalidity symbol of the current altitude is for example the form of a cross inside a disc.

The absence of measurement of the current altitude for example results from a situation upon starting the display system 16, in which the sensor(s) measuring the current altitude of the aircraft 10 have not yet provided data. Such an absence of measurement of the current altitude may also result from a situation in which the sensor(s) for measuring the current altitude of the aircraft 10 do not receive a signal, for example on the ground in a hanger. The disrupted measurement of the current altitude of the aircraft 10 for example results from scrambling of the signal of at least one sensor measuring the current altitude of the aircraft 10.

The detection module 38 then makes it possible to offer continuous use of the field map 22 to the user, while in this case indicating to him the deteriorated condition resulting from the invalidity of the current altitude of the aircraft 10, through the generation and display of the corresponding invalidity symbol.

The aircraft symbol 48 is preferably in the form of an icon depending on the type of the aircraft 10. In the example of FIGS. 2 to 5 where the aircraft 10 is a helicopter, the aircraft symbol 48 is then in the form of a helicopter in side view.

The position symbol 56 is also preferably in the form of an icon depending on the type of the aircraft 10. In the example of FIGS. 2 to 5 where the aircraft 10 is a helicopter, the position symbol 56 is then in the form of a helicopter in top view.

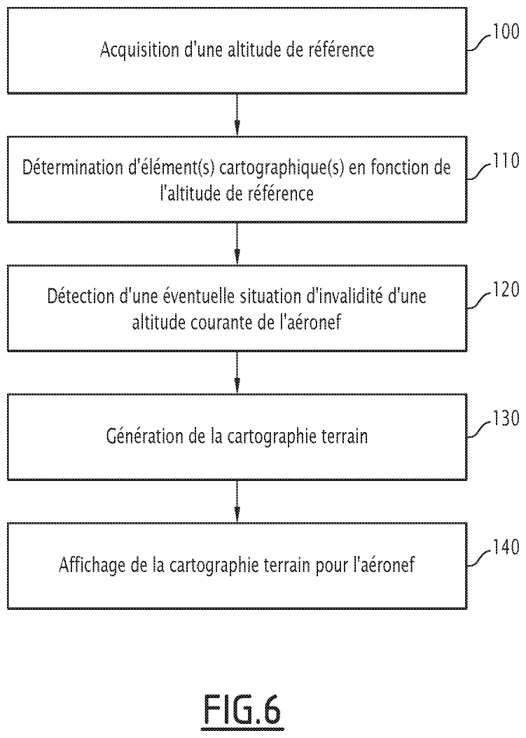

The operation of the display system 16, and in particular of the display management device 20, according to the invention will now be described in light of FIG. 6, showing a flowchart of the method according to the invention, for managing the display of the field map 22 for the aircraft 10.

During an initial step 100, the management device 20 acquires, via its acquisition module 24, the reference altitude of the aircraft 10, in the first mode M1, or automatic mode, in which the reference altitude depends on the current altitude of the aircraft 10, or in the second mode M2, in which the reference altitude depends on an altitude value entered by the user via the entry interface 26.

During the acquisition step 100, the first mode M1, or automatic mode, is activated if no interaction with said entry interface 26 is detected, and the second mode M2, or manual mode, is activated only if an interaction by the user with the entry interface 26 is detected.

During the acquisition step 100, the acquisition mode 24 further switches from the second mode M2, or manual mode, to the first mode M1, or automatic mode, once a switching condition is met, so as to prevent the acquisition module 24 from remaining in manual mode M2 without the user being aware.

During the acquisition step 100, when the aircraft 10 is in flight, the switching condition is preferably the end of the interaction by the user with the entry interface 26, and this switching condition is further preferably unique. In other words, during the acquisition step 100, when the aircraft 10 is in flight, the acquisition module 24 returns to the first mode M1 (or automatic mode), once the user no longer interacts with the entry interface 26, for example once he no longer selects the aircraft symbol 48 and/or once he releases the value tag 54 after a movement of this value tag 54.

This then makes it possible to authorize the second mode M2, or manual mode, even when the aircraft 10 is in flight, so as for example to make it possible to secure a diversion of the aircraft 10, while guaranteeing that the user, such as the pilot or the copilot of the aircraft 10, is fully aware of the fact that what he is viewing is not the situation relative to the current altitude of the aircraft 10, because he is in the process of manually modifying the value of the reference altitude, for example by interacting with the altitude scale 46 and the aircraft symbol 48. The immediate return at the end of the interaction to the first mode M1, or automatic mode, next makes it possible to limit a risk of incorrect interpretation of the field map 22 by the user following a previous manual use.

During the acquisition step 100, when the aircraft 10 is on the ground, the switching condition is preferably chosen among the expiration of the time delay, typically in the order of 60 seconds, triggered after the last interaction by the user with the entry interface 26, and the interaction of the user with the switching interface in automatic mode. In other words, when the aircraft 10 is on the ground, the passage to the first mode M1 (or automatic mode) is done manually upon interaction by the user with said switching interface in automatic mode, this interaction for example being a double tap or a double-click on the aircraft symbol 48, or on the value tag 54. When the aircraft 10 is on the ground, the return to the first mode M1, or automatic mode, will be done in all cases automatically upon expiration of said time delay, typically about 60 seconds, after the last interaction by the user with the entry interface 26.

This then makes it possible to offer a comfortable use of the display of the field map 22 when the aircraft 10 is on the ground, for example in mission preparation, to simulate future flight levels and to verify the safety of the flight plan with respect to the terrain. These switching conditions next make it possible to limit the risks of an incorrect interpretation, by providing an automatic return to the first mode M1, even if the user forgets to switch back to this first mode M1.

The management device 20 next determines, via its determining module 28 and during the following step 110, the cartographical element(s) 30, 32, as a function of the reference altitude, that was acquired during the initial step 100. During this determining step 110, the determining module 28 for example compares the reference height, or the range of altitudes, of each cartographical element 30, 32 to the reference altitude, and then determines the first cartographical element(s) 30 as being those having a reference height greater than the reference altitude when the first cartographical element(s) 30 are each a relief zone or an obstacle, or respectively those whose range of altitudes includes the reference altitude when the first cartographical element(s) 30 are each an airway or an airspace.

During this determining step 110, the determining module 28 also determines the second cartographical element(s) 32 as being those having a reference height less than or equal to the reference altitude when the second cartographical element(s) 32 are each a relief zone or an obstacle, or respectively those whose range of altitudes does not include the reference altitude when the second cartographical element(s) 32 are each an airway or an airspace.

During an optional following step 120, the management device 20 detects, via its detection module 38, an optional situation of invalidity of the current altitude of the aircraft 10, such as an absence of measurement of the current altitude or a disrupted measurement of said current altitude.

The management device 20 next generates, during the following step 130 and via its generating module 34, the field map 22, in particular from the cartographical element(s) 30, 32 determined during step 110, relative to the reference altitude acquired during step 100.

During this generating step 130, and as an optional addition, the generating module 34 also generates the altitude scale 46, representing the range of reference altitude values, with the aircraft symbol 48 indicating the current value of the reference altitude, this aircraft symbol 48 being movable along the altitude scale 46, as well as the graduations 50, the value legends 52, if applicable the value tag 54, and the position symbol 56.

During this generating step 130, the generating module 34 also generates the out-of-range symbol 58 if the current value of the reference altitude is not included in the range of reference altitude values corresponding to the altitude scale 46.

As another optional addition, the generating module 34 generates the invalidity symbol for the current altitude when the detection module 38 has previously detected, during step 120, a situation of invalidity of the current altitude of the aircraft 10, and the invalidity symbol of the current altitude is then generated in place of the aircraft symbol 48. This makes it possible to ensure that the field map 22 is always usable by the user, even under deteriorated conditions.

The management device 20 lastly displays, during the following step 140 and via its display module 36, the field map 22 previously generated during step 130 by the generating module 34.

As an optional addition, the display module 36 also displays, during the display step 140, the altitude scale 46 with the aircraft symbol 48, or if applicable the invalidity symbol for the current altitude, with the graduations 50, the value legends 52, if applicable—that is to say if the aircraft symbol 48 has been selected—the value tag 54, as well as the position symbol 56 representative of the position of the aircraft 10 in top view.

As another optional addition, if the current value of the reference altitude is not included in the range of reference altitude values corresponding to the altitude scale 46, the display module 36 also displays, during the display step 140, the out-of-range symbol 58 representative of the fact that the current value of the reference altitude is not included in said range of reference altitude values.

The display system 16, the management device 20 and the method for managing the display according to the invention then make it possible to improve the safety of the flight of the aircraft 10, in particular at low altitudes, by allowing the user to become aware of the situation of the aircraft 10 (situation awareness) relative to the surrounding relief and to then anticipate a future change in trajectory while preserving a sufficient altitude margin with respect to the terrain.

One can thus see that the method and the display management device 20 according to the invention offer a more effective display of the cartographical element(s) 30, 32 and make it possible to further improve the safety of the flight of the aircraft 10.

1. A method for managing the display of a field map for an aircraft, the method being implemented by an electronic management device and comprising:
acquiring a reference altitude of the aircraft, using a mode chosen from an automatic mode in which the reference altitude depends on a current altitude of the aircraft and a manual mode in which the reference altitude depends on an altitude value entered by a user via a reference altitude entry interface;
determining cartographical element(s) based on the reference altitude;
generating the field map, said map including a representation for each cartographical element,
wherein, during the acquisition, the manual mode is activated if an interaction by the user with the reference altitude entry interface is detected, and the automatic mode is activated if no interaction with said entry interface is detected,
the acquisition further includes switching from the manual mode to the automatic mode if a switching condition is met, and
when the aircraft is in flight, the switching condition is the end of the interaction by the user with the reference altitude entry interface.

2. The method according to claim 1, wherein when the aircraft is on the ground, the switching condition is chosen from the group consisting of: the expiration of a time delay triggered at the end of the interaction by the user with the reference altitude entry interface; and an interaction by the user with a switching interface in automatic mode.

3. The method according to claim 1, wherein the reference altitude entry interface is associated with an altitude scale representing a range of reference altitude values, with an aircraft symbol indicating a current value of the reference altitude, the aircraft symbol being movable along the altitude scale, the altitude scale and the aircraft symbol being intended to be displayed superimposed on the field map.

4. The method according to claim 3, wherein the reference altitude entry interface includes a member for selecting the aircraft symbol and a member for moving a value tag appearing after a selection of the aircraft symbol.

5. The method according to claim 3, wherein the reference altitude entry interface is touch-sensitive.

6. The method according to claim 1, wherein the method further comprises detecting a situation of invalidity of the current altitude of the aircraft, and the generation then further includes generating an invalidity symbol of the current altitude.

7. The method according to claim 6, wherein the situation of invalidity of the current altitude of the aircraft is an absence of measurement of the current altitude or a disrupted measurement of the current altitude.

8. The method according to claim 1, wherein, during the acquisition in the automatic mode, the reference altitude is equal to the current altitude of the aircraft minus a predetermined margin.

9. The method according to claim 8, wherein the predefined margin is equal to 300 feet within +/−10%.

10. The method according to claim 8, wherein the predefined margin is configurable in a plant.

11. The method according to claim 1, wherein each cartographical element is chosen from the group consisting of: a relief zone, an obstacle, an airspace, an airway and meteorological information.

12. The method according to claim 1, wherein the determining includes determining first cartographical element(s), and respectively second cartographical element(s), based on the reference altitude, and the generating includes generating a first representation for each first cartographical element and a second representation for each second cartographical element, each second representation being distinct from each first representation.

13. The method according to claim 12, wherein when the first and second cartographical element(s) are each a relief zone, each first cartographical element has a reference height greater than the reference altitude, and each second cartographical element has a reference height less than or equal to the reference altitude.

14. The method according to claim 12, wherein when the first and second cartographical element(s) are each an obstacle, each first cartographical element has a reference height greater than the reference altitude, and each second cartographical element has a reference height less than or equal to the reference altitude.

15. The method according to claim 12, wherein when the first and second cartographical element(s) are each an airspace, each first cartographical element has a range of altitudes including the reference altitude, and each second cartographical element has a range of altitudes not including the reference altitude.

16. The method according to claim 12, wherein when the first and second cartographical element(s) are each an airway, each first cartographical element has a range of altitudes including the reference altitude, and each second cartographical element has a range of altitudes not including the reference altitude.

17. The method according to claim 1, wherein the method further comprises displaying the field map on a display screen.

18. The method according to claim 17, wherein the displaying further includes a display of a position symbol representative of the position of the aircraft.

19. A non-transitory computer-readable medium including a computer program comprising software instructions which, when executed by a computer, carry out a method according to claim 1.

20. An electronic management display management device of a field map for an aircraft, the device comprising:
an acquisition module configured to acquire a reference altitude of the aircraft, using a mode chosen from an automatic mode in which the reference altitude depends on a current altitude of the aircraft and a manual mode in which the reference altitude depends on an altitude value entered by a user via a reference altitude entry interface;
a determining module configured to determine one or several cartographical element(s) based on the reference altitude;
a generating module configured to generate the field map, said map including a representation for each cartographical element,
wherein the acquisition module is configured to activate the manual mode if an interaction by the user with the reference altitude entry interface is detected, and to activate the automatic mode if no interaction with said entry interface is detected,
the acquisition module is further configured to switch from the manual mode to the automatic mode if a switching condition is met, and
when the aircraft is in flight, the switching condition is the end of the interaction by the user with the reference altitude entry interface.

21. An electronic system for displaying a field map for an aircraft, the system comprising a display screen and an electronic management device configured to manage the display of the field map on the display screen, wherein the electronic management device is according to claim 20.
